(19) United States
(12) Patent Application Publication
(10) Pub. No.: US 2026/0237251 A1
(43) Pub. Date: Aug. 13, 2026

(54) METHOD FOR MONITORING A TECHNICAL SYSTEM WITH REGARD TO A CHANGE OF STATE OF A COMPONENT OF THE TECHNICAL SYSTEM

(71) Applicant: Robert Bosch GmbH, Stuttgart (DE)

(72) Inventors: Dominik Germek, Berlin (DE); Christopher Huth, Heilbronn (DE); Martin Ring, Lossburg (DE); Andreas Heyl, Weil Der Stadt (DE); Christoph Boesch, Kirchentellinsfurt (DE); Peter Schneider, Holzgerlingen (DE)

(21) Appl. No.: 19/462,405

(22) Filed: Jan. 28, 2026

(30) Foreign Application Priority Data
Feb. 7, 2025 (DE) 10 2025 104 493.7

(51) Int. Cl. G07C 5/08; B60T 17/22

(52) U.S. Cl. CPC G07C 5/0808; B60T 17/22

(57) ABSTRACT

A method for monitoring a technical system, in particular a vehicle, with regard to a change of state of a component of the technical system. The method includes: providing component data of the technical system; providing change data that include a plurality of change decompositions, wherein the change decompositions each include one or more function blocks that are obtained by decomposing a description of a change of state with respect to a component of the technical system; providing event data that include information about state change events; if there is a state change event: providing a current history of context parameter values for context parameters; and determining, based on at least part of the current history of context parameter values and the change decompositions, whether there is a discrepancy between a state of the component and the change of state according to the state change event.

### FIELD

The present disclosure relates to a method for monitoring a technical system, in particular a vehicle, with regard to a change of state of a component of the technical system, and also to a computing unit and to a computer program for performing the method.

### BACKGROUND INFORMATION

In vehicles or other technical systems, components can change their state, or the state of components can be changed. This can happen, for example, during maintenance (a visit to a repair shop) or in the event of an accident. It can then be relevant whether the component still behaves as desired after the change in state.

### SUMMARY

The present disclosure provides a method, in particular a computer-implemented method, for monitoring a technical system, along with a computing unit and a computer program for performing the method. The following description relates to advantageous embodiments.

The present disclosure deals with monitoring technical systems with regard to changes of state of components of technical systems. In particular, a technical system can be part of a cyber-physical system (CPS). A cyber-physical system can be understood in particular as a network of information technology software components with mechanical and electronic parts that communicate via a data infrastructure, such as the Internet. It allows, for example, the control and monitoring of complex systems and infrastructures. Therefore, part of a cyber-physical system is in any case a technical system in which the state of a component can change. A specific example of a technical system is a vehicle that is then-in the sense of a cyber-physical system-e.g., communicatively connected to the Internet. A specific example of a component of a vehicle is in turn a brake (or a braking system or a part thereof).

The present disclosure then provides a possibility of detecting discrepancies in the state of a component of the technical system (or CPS), in particular automatically. This should be done based on changes of state, in particular changes in property values of the components, possibly over a longer period of time. Specifically, it can be detected, for example, whether the components of a system (e.g., a vehicle) behave as expected after the occurrence of a specific event, such as a maintenance measure, a crash, a software update, a tuning measure, etc. In this way, for example, predictive maintenance of the system can be performed, and it can be verified whether changes have been performed as expected in the maintenance. It can also be used to detect, for example, potential tampering with the system components caused by cybersecurity or other factors.

Although the present disclosure is described hereinafter for improved explanation, in particular in relation to vehicles and the components thereof, it can, however, also be used with other technical systems such as, e.g., a robot, a building, in particular a factory or a hospital, a smart home, or a smart town or smart city. For vehicles themselves, passenger cars, trucks and other vehicles such as motor trucks or buses are also contemplated, as well as vehicles on water and in the air (thus, e.g., ships, boats and airplanes or helicopters). Basically, any system that has some form of sensors and digital processing, e.g., a mobile phone, can be used as a technical system.

The present disclosure makes vehicle diagnostics possible, for example using virtual sensors. The method according to the present disclosure is helpful in particular for the long-term maintenance of the hardware and the software used in parallel, in particular regarding the question of where changes in the vehicle's behavior are to be expected. This allows for monitoring of a larger fleet, but also of individual vehicles.

Specifically, it can be established, for example, whether a service was performed in a car repair shop (e.g., engine oil was not changed even though it should have been changed or payment was made therefor) or whether a car was damaged or tampered with while it was being operated by another driver.

Hereinafter, various terms used within the framework of the present application are initially briefly explained.

Function block: A function block is the smallest meaningful functional part of a software package or piece of software, which part is represented, or can be represented, in a broken-down or decomposed manner. A function block could, for example, be a function or a number of functions that implement a specific behavior. In particular, it is proposed to represent function blocks in the form of textual (and thus human-readable) descriptions. An example of a function block could be a function that executes the following action: “Connect to the remote server using a protocol such as FTP or SFTP.”

Functional area: A functional area is a functional area (or region) of a group of function blocks that are related to one another and implement a specific, more complex behavior. For example, a functional area could be a group of function blocks that perform an attack, e.g., pass confidential information to a remote server. The functional area that represents this attack could thus consist of the following function blocks:
1) Turn off logging.
2) Open the desired local file in read mode.
3) Read the content of the file.
4) Connect to the remote server using a protocol such as FTP or SFTP.
5) Open a file on the remote server in write mode.
6) Write the content read from the local file to the remote file.
7) Close the remote file.
8) Close the local file.
9) Continue logging.

Decomposition: A decomposition is in particular the software in its entirety (i.e., for example, a software package), which is represented in the form of connected function blocks.

Within the scope of the present disclosure, however, this concept of decompositions (and thus also of function blocks etc.) is not to be related to software, or not only to software, but (also) to a different interpretation. Decomposition is meant to define how a set of properties (or states) changes when a particular component (which can be a hardware component or a software component) is modified or altered.

The present disclosure provides component data that comprise information about components of the technical system. This can, for example, be a list of all vehicle components connected to the vehicle. A specific vehicle can be identified, for example, by means of a unique ID (this applies accordingly to a technical system in general). The list of components can be extracted, for example, by parsing and analyzing specifications of the technical system and sensor specifications and querying LLMs, parsing online resources, or by manual input. A combination of these is also possible. Such a list can also be provided by a manufacturer (OEM) of the vehicle or technical system.

Optionally, these components can also be filtered so that the component data only comprise information about relevant components. One reason for performing filtering may be, for example, to remove irrelevant components that are not relevant to a specific use case, or to remove components based on the settings of users (e.g., drivers), e.g., due to considerations regarding the protection of privacy in relation to the relevant context parameters, and the like.

Context parameters are also used, which are, for example, comprised in context parameter data. Context parameters (or context-related parameters) are each related to a context of a component of the technical system. Of particular interest are context parameters that could be relevant for verifying the change. For a brake pad component, for example, the context parameters indicate values with respect to braking performance, brake wear, brake temperature, brake pressure, brake pedal feel, and others. In general, the context parameters can include, for example, the performance of the component or of a part thereof; the noise of the component or of a part thereof; the vibration of the component or of a part thereof; the wear and tear of the component or of a part thereof; the heat resistance of the component or of a part thereof; the actuation behavior of the component or of a part thereof; the speed of the technical system; the weight of the technical system; and the balance of the technical system.

The context parameters can be collected by identifying potential context parameter sources (e.g., vehicle sensors; here, physical and/or virtual sensors are considered) via machine learning models (e.g., LLMs), parsing and analyzing online sources, specifications of the technical system, sensor specifications, etc. The collection of context parameters is performed in particular for all components in the component data. Furthermore, all other available context parameters that are not (or not necessarily) related to the vehicle components can be collected, in particular in the same way. For example, the current speed of the vehicle is not directly related to a vehicle component, but can still be relevant for checking the change of state. For each technical system, other or comparable parameters are correspondingly contemplated.

Like the components, the context parameters can be filtered, in particular for the same reasons.

Furthermore, change data that comprise a plurality of change decompositions are provided. The change decompositions each comprise one or more function blocks that are obtained, or have been obtained, by decomposing a description of a change of state with respect to a component of the technical system.

Descriptions of changes of state based on the vehicle components can therefore be collected here. A “description” refers in particular to any readable and parsable (i.e., machine-readable and processable) format that describes a change of state in the context of vehicles. A change of state description could, for example, be a report that describes how the brake pads are worn down over time and what properties change in a vehicle when the brake pads are replaced with new ones. Sources for descriptions of changes of state include (among others): an existing database of descriptions of changes of state, Internet blogs, vehicle specifications, accident reports, direct user input, vehicle maintenance manuals, and the like. The descriptions can be extracted using, for example, machine learning models (e.g., LLMs), (web) parsers, or manually, etc.

The descriptions of changes of state can then be decomposed or translated into decompositions (change decompositions). A decomposition is, in particular, a structured representation of a description of a change of state, which defines which properties are changed, such as by a component change. In particular, the decompositions define how a set of properties or states changes when a specific component is replaced. For example, a change decomposition could define the following expected changes in vehicle properties when a brake pad is replaced: brake pad wear, braking performance, brake temperature, brake pressure, brake pedal feel, and others. The change decompositions can be used to shift the current state of the vehicle components to the expected state. For example, a change decomposition could define the following expected properties that are meant to change after the replacement of the brake pads: improved braking performance, reduced wear on other brake components, noise and vibration reduction during braking, fewer brake dust deposits, possible improvement in fuel efficiency.

In general, state change events can include, for example, performing maintenance on the component or on a part thereof; replacing the component or a part thereof; performing maintenance on the technical system or on a part thereof; replacing a part of the technical system; an accident involving the technical system (particularly relevant for vehicles) ; tuning the component or the technical system or a part thereof; lending the technical system to a third party.

The change decompositions can be viewed as a list of instructions that need to be verified to establish if the state has changed as expected. The example mentioned comprises context parameters such as “braking performance,” “wear of other brake components,” “noises and vibrations during braking,” “brake dust accumulation” and “fuel efficiency.”

The representation of the decomposition is carried out, in particular, as, or using, a so-called decomposition-based control flow graph (DCFG). A control flow graph (CFG) is a data Structure in computer science used, e.g., in compilers. Here, a change decomposition, for example, can be decomposed into a CFG, in which each basic block (a basic block is a straight-line code sequence with no branches into it except at the entry and no branches out of it except at the exit) is represented as a collection of function blocks. A functional area can contain one or more basic blocks within the DCFG, depending on which functionality is reflected in the CFG. The function blocks are, in particular, represented as human-readable descriptions. The functional areas are thus groups of function blocks implementing a particular behavior.

Furthermore, event data that comprise information about state change events are provided. The state change events each indicate a change of state with respect to a component of the technical system. This is in particular the occurrence or desired occurrence of a change of state. State change events can be collected in particular through user input (e.g., also from an OEM) or through resource extraction from existing sources (e.g., vehicle service manuals, accident reports, vehicle specifications, querying LLMs, and others). A state change event is an event (or a description of an event) that triggers a change of state in the context of the component or the technical system in general. Each state change event should be uniquely identifiable. Examples of state change events include regular vehicle maintenance, component replacement, software updates, tuning, tire changes, lending the vehicle to another driver, crash events, and others. For other types of technical systems, there may accordingly be different state change events.

Like the components and context parameters, the state change events can be filtered, in particular for the same reasons. For example, if a particular state change event is not relevant to the use case, it can be deactivated or ignored, which avoids unnecessary storage in memory, for example.

Based on the cited data, i.e., component data, change data and event data, the actual monitoring of the technical system can then be carried out. Collecting and, if applicable, generating the cited data does not need to be carried out in the cited sequences and can also be carried out repeatedly, in the sense of an update. In particular, it is important that these data are available and that they can be used for the monitoring.

If there is a state change event, a current history of context parameter values for the context parameters is provided. Specifically, the context parameter values pertain to the (current) values of the context parameters. The context parameter values are the actual values of the context parameters that describe the context. Like the context parameters, the context parameter values can be filtered, in particular for the same reasons. For example, if a particular context parameter value is unreadable due to a missing sensor, the context parameter values that rely on that context parameter can be deactivated to avoid unnecessary checks.

In order to obtain the current history, in one embodiment, available context parameter values for the context parameters can be determined repeatedly or continuously, in particular during operation of the technical system, and then added to the (already existing) history of context parameter values. This allows a current version of the history of context parameter values to be retrieved or provided if needed.

Based on at least part of the current history of context parameter values and the change decompositions, it is then determined whether there is a discrepancy between a state of the component and the change of state according to the state change event. In particular, it is checked whether the state of the component has changed or is changing in the way that would be expected for the state change event. The change to be expected is determined in particular using the change decompositions. For example, if the state change event of a repair shop service with brake replacement occurs, it is checked whether the state of the brake (or possibly other components) has changed as is to be expected for new brakes. If this is not the case, i.e., there is a discrepancy, it can be assumed, for example, that the brake change was not performed even though the repair shop indicated that it was.

In one example embodiment, if there is a discrepancy, at least one measure is determined. Then information about the at least one measure is provided, i.e., for example, a signal is output that can be used to implement the measure. In particular, the at least one measure is also initiated. Measures that may be considered include, in particular, warning messages and/or recommendations for action, in particular to the user of the technical system or vehicle or another connected and relevant service. The warning message comprises, for example, all relevant data that support the established discrepancy, such as the change decompositions, the associated event, a user ID and a vehicle ID, relevant or all context parameter values, context parameter trend information, and the like.

In one example embodiment, action data that comprise a plurality of action decompositions are also provided. The action decompositions each comprise one or more function blocks that are obtained, or have been obtained, by decomposing an action to be carried out in the event of a discrepancy. The at least one measure then comprises at least one action corresponding to the discrepancy according to the action data, or a recommendation to initiate the at least one action. This may include the aforementioned warning messages and/or recommendations for action.

In one example embodiment, there is or is deemed to be a state change event if at least one of various criteria occurs. These criteria can include whether the state change event is manually triggered externally, whether the state change event is automatically triggered externally, or whether, as part of an automatic, in particular continuous, check, it is determined that there is a state change event.

For example, the user, the vehicle (or another service), or a regular automatic timer can trigger the state change event. For example, if the user decides to replace the brake pads, the “Replace brake pads” event is triggered. It should be noted that the triggering can also be carried out automatically by the vehicle (or the technical system in general). For example, if the vehicle detects an accident, the accident event is triggered. A regular timer can be used, for example, to trigger regular checks. For example, the regular check could be used to establish whether certain components of a vehicle are deteriorating too quickly or suddenly behaving differently. In this use case, the proposed approach can therefore be used for the predictive maintenance of the vehicle components. It should be noted that the timer can be set, for example, to continuous checking.

In one example embodiment, the at least one measure is further determined based on a history of context parameter values of the technical system and/or of the user. This history can then be updated based on the at least one measure. This history (contextual history) can therefore comprise previous anomalous situations that led to an action or measure. The history can be used to learn from past events, improve the system, provide insights to the user and much more. Here, the user can even be involved in the learning process by providing feedback on the performed measures (e.g., the user can give feedback if a false positive was detected).

The proposed approach thus closes the gap between (cyber) security attacks and safety-relevant situations or incidents in vehicles, and offers a way to detect inconsistencies and prevent potential safety-relevant incidents, thereby protecting, for example, the driver and their property. In this case, it can be detected, for example, that the properties of a particular component are changing in a certain way that is not expected (or that the properties of a component are not changing at all, even though they should). Sources of these changes include (cyber) security attacks as well as safety-related wear requiring corresponding maintenance.

Specific examples of use cases for the proposed approach include, for example, establishing that a vehicle repair shop (service station) has not provided the required service on the vehicle (e.g., the engine oil was not changed even though it was paid for). It can be detected that a vehicle component is aging, aging too quickly, or is changing in a different (unexpected) manner. This allows for the possibility of predictive maintenance. It can be detected that a vehicle component is not functioning as expected after an accident. This approach can also be used to request help or to inform the authorities in the event of an accident.

Potentially undesired changes to the vehicle can be detected and the owner informed. For example, if an attacker tampers with or replaces a vehicle component, this can be detected and the user can be informed (e.g., via their smartphone or the like). It is possible to detect whether a vehicle has been tuned without the owner's knowledge. This use case can be extended to the case where a driver purchases a new (or used) vehicle. In this case, it can be detected whether the vehicle was tuned or tampered with before the driver purchased it by comparing the history of the context parameter values to the context parameter values of the predecessor vehicle (assuming that the old and the new vehicle are the same model). It can be detected whether a vehicle has been damaged or tampered with while being driven by another driver.

The proposed method can be integrated in particular into the stack of an automated driving system (AD) or ADAS system and communicate or prescribe a driving style or driving behavior that minimizes the possibility of a safety incident due to unexpected context parameter values of components. The AD/ADAS systems can thus mitigate potential safety risks, for example by choosing alternative driving maneuvers or by temporarily passivating AD/ADAS functions. For example, the AD system could limit the vehicle's speed depending on the reported context parameter values of the brake pads, in order to still remain in a driving state that allows for safe braking maneuvers.

A computing unit according to the present disclosure, e.g., a computer or server (e.g., also in the so-called cloud), or a control unit of a vehicle or of another technical system, is configured, in particular in terms of programming, to perform a method according to the present disclosure. In particular, computations can thus also be outsourced, e.g., to the so-called cloud, wherein communication with a vehicle for relevant data is carried out via a suitable communication connection. Thus, in the underlying data being provided, data from other vehicles or systems that are connected, e. g., via V2X (e.g., a “collective perception message” provided by V2X), can also be taken into account.

Furthermore, the implementation of a method according to the present disclosure in the form of a computer program or computer program product having program code for performing all the method steps is advantageous because it is particularly low-cost, in particular if an executing control unit is also used for further tasks and is therefore present anyway. Finally, a machine-readable storage medium having a computer program as described above stored thereon is provided. Suitable storage media or data carriers for providing the computer program are, in particular, magnetic, optical, and electric storage media, such as hard disks, flash memory, EEPROMs, DVDs, and others. It is also possible to download a program via computer networks (Internet, intranet, etc.). Such a download can take place in a wired or wireless manner (e.g., via a WLAN network or a 3G, 4G, 5G or 6G connection, etc.).

Further advantages and embodiments of the present disclosure can be found in the description and the figures.

The present disclosure is shown schematically in the figures on the basis of exemplary embodiments and is described below with reference to the figures.

### BRIEF DESCRIPTION OF EXAMPLE EMBODIMENTS

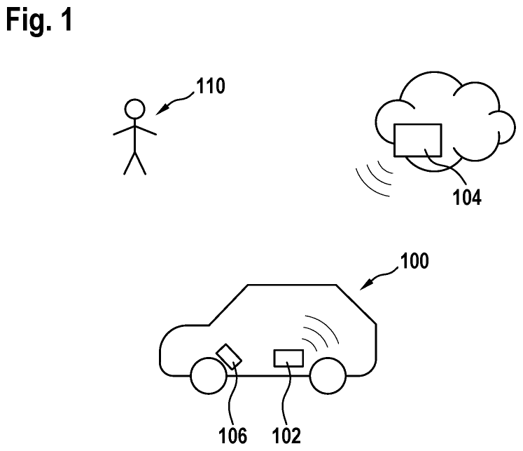

FIG. 1 schematically shows a technical system in which the present disclosure can be used.

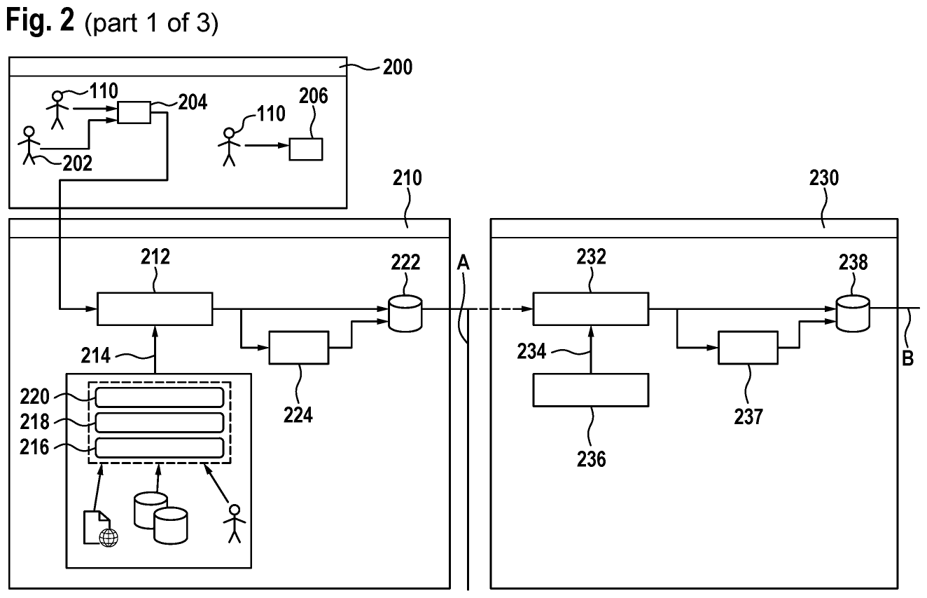

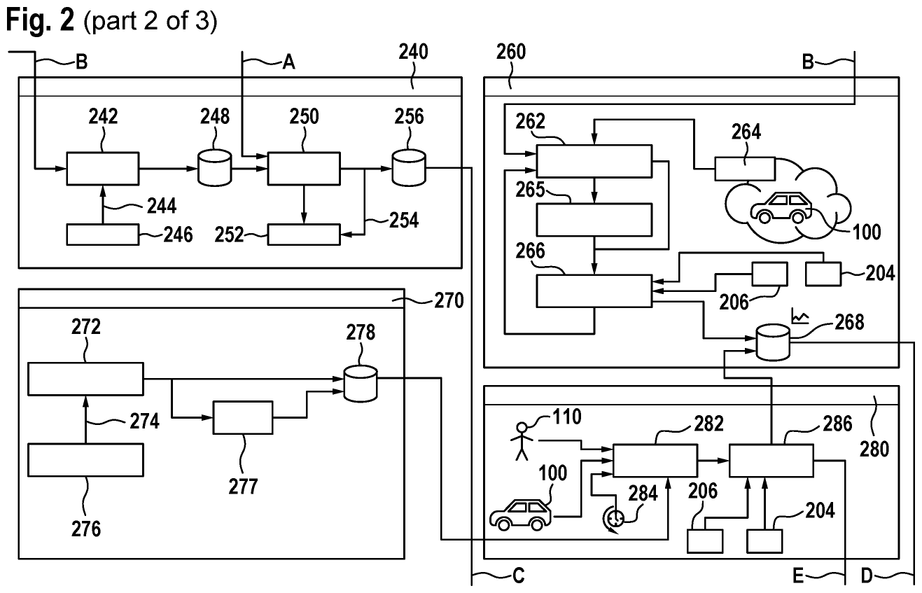

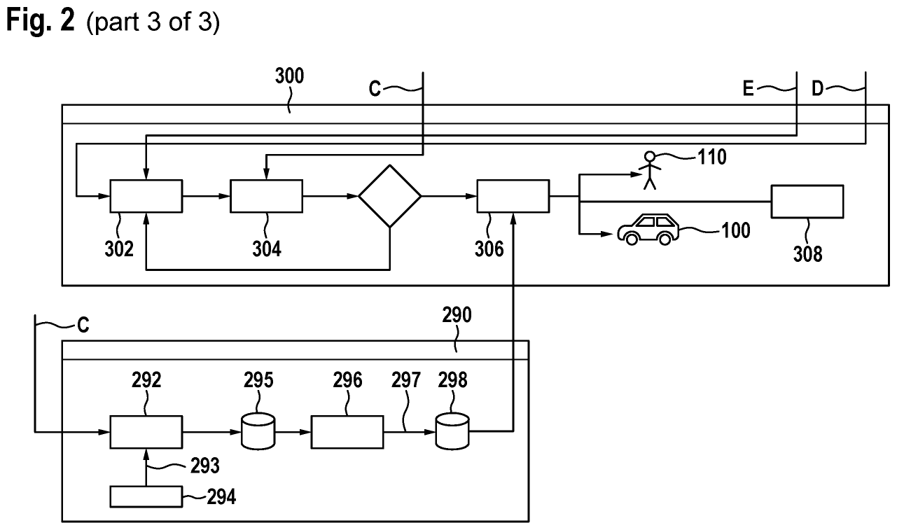

FIGS. 2A-2C schematically show a sequence of a method in one embodiment.

### DETAILED DESCRIPTION OF EXAMPLE EMBODIMENTS

In FIG. 1, a technical system 100 designed as a vehicle in which the present disclosure can be used is schematically shown. The vehicle 100 has a computing unit 102 designed as a control unit which can be connected, e.g., via a wireless communication connection that is only indicated, to a server 104, e.g., the so-called cloud. The vehicle 100 also has, by way of example, a component 106 designed as a brake. As explained above in detail, there can be many other components that can be monitored with regard to changes of state. In addition, a user (or driver) 110 of the vehicle is shown.

A sequence of a method for monitoring a vehicle (as an example of a technical system) with regard to a with regard to a change of state of a component is shown, in one embodiment, in FIGS. 2A-2C. Here, steps are shown in blocks, with connections between the blocks being understood according to the lines or arrows denoted A to E.

First, in step 200, a user ID and a vehicle ID can be determined or defined. A user 110 or a manufacturer (OEM) 202 can define the vehicle ID 204. The user 110 can be assigned a user ID 206. These IDs (or identifiers) serve in particular to specifically assign data or results etc. to the vehicle or user.

In a step 210, component data are provided. This can comprise, in particular, that initially, in step 212, information 214 about components is collected. This can be, for example, a list of components of a specific vehicle. This information can be collected in various ways, e.g., by means of a manual description 216 by an expert, an automatic extraction 218 from the various sources via parsers, crawlers or even by querying 220 LLMs. The result thereof is a list of components that can be stored, e.g., in a database 222.

Optionally, relevant components or the information about them can be filtered out, in step 224, in order to obtain the list of components in the database 222.

In a step 230, context parameter data are provided. For this purpose, in step 232, a plurality of context parameters 234 are collected which are related to a context of a component of the technical system or of the vehicle. As mentioned, this can be done based on human input, online resources, analysis of vehicle sensors or sensors in general of the technical system, in-vehicle systems, and the like. Generally, this can be referred to as an extraction 236. These context parameters are related to the component of the vehicle, i.e., they describe, for example, the context of the vehicle component, such as a brake. However, such parameters can also be related to a context of the technical system or vehicle itself, such as driving speed, etc. For further examples of context parameters, reference is made to the explanations above. The context parameters obtained in this way can then be stored, possibly after filtering in step 237, in a database 238 and thus-as context parameter data-provided for further use.

It should be mentioned again at this point that the components (cf. database 222) can be modifiable, replaceable or repairable components; this can happen, for example, during maintenance (or unintentionally in the event of an accident). The context parameters (cf. database 238), on the other hand, are measurable properties of these components and, if applicable, other properties of the vehicle.

In a step 240, change data are provided. For this purpose, in step 242, descriptions of changes 244 of state each with respect to a component of the technical system can be collected. A “description” refers in particular to any readable and parsable format that describes a change of state in the context of vehicles. As mentioned, this can be done based on Internet blogs, vehicle specifications, accident reports, direct user input, and the like. Generally, this can be referred to as an extraction 246. For further examples of changes of state, reference is made to the explanations above. The descriptions obtained in this way of changes of state can then be stored in a database 248.

In a step 250, the collected descriptions of changes of state are then decomposed in order to obtain change decompositions. Here, the above-mentioned concept of decomposition can be used. The change decompositions obtained in this way can then be stored in a database 256 and thus-as change data-provided for further use. Optionally, in step 252, relevant change decompositions 254 can be filtered out and stored in the database 256, thus obtaining the change data with the change decompositions.

In a step 260, available context parameter values are collected repeatedly or continuously. Specifically, in step 262, available context parameter values for the context parameters can be determined, e.g., from the vehicle 100 or its components. These can optionally be filtered in step 265. In step 266, the available context parameter values (possibly after filtering) are added to a history of context parameter values. This history is denoted here as 268 and presented as a database.

In a step 270, event data are provided. For this purpose, in step 272, a plurality of state change events 274 that each indicate a change of state with respect to a component of the technical system or the vehicle are collected. As mentioned, this can be done based on human input, online resources, and the like. Generally, this can be referred to as an extraction 276. For examples of K state change events, reference is made to the explanations above. The state change events obtained in this way can then be stored, possibly after filtering in step 277, in a database 278 and thus-as event data-provided for further use.

The above-cited steps do not need to be carried out Sequentially, but can be executed, at least in part, also in parallel. Attention must be paid only to whether results of one step are needed in another step. These steps can also be repeated repeatedly or carried out continuously in order to be able to maintain data that are always as current as possible. The collecting of the context parameter values in particular (cf. step 260) should however be carried out repeatedly or continuously.

Then, in step 280, it can be checked whether a state change event occurs. In step 282, a state change event is triggered, for example. This can be done, for example, manually by the user 110, by the vehicle 100, or by a regular check 284. Therefore, if a state change event occurs or has occurred, it can be recorded with the history in step 286. In particular, the user ID 206 and the vehicle ID 204, the event itself and other relevant data (e.g., the timestamp) can be stored in the history or the corresponding database. This recording is necessary in particular to track the event and to allow the detection of discrepancies.

In parallel, a discrepancy detection, in step 300, can be initiated.

First, however, action data can be provided in step 290. For this purpose, in step 292, a plurality of actions 293 each of which is to be carried out in the event of a discrepancy is collected. This can involve measures or recommendations for action. As mentioned, this can be done based on human input, online resources, and the like. Generally, this can be referred to as an extraction 294. For examples of actions, reference is made to the explanations above. The actions obtained in this way can then be stored in a database 295.

In a step 296, the collected actions are then decomposed in order to obtain change decompositions. Here, the above-mentioned concept of decomposition can be used. The action decompositions 297 obtained in this way can then be stored in a database 298 and thus-as action data-provided for further use.

In step 300, when a discrepancy is detected (as mentioned above), step 302 allows for the retrieval of a current version of the history of context parameter values-thus providing a current history of context parameter values. In step 304, based on at least part of the current history of context parameter values and the change decompositions, it is determined whether there is a discrepancy between a state of the component and the change of state according to the state change event. This can be done through a comparison.

If this is not the case, step 304 may be repeated. However, if this is the case, i.e., if there is a discrepancy, at least one measure 308 can be determined in step 306. As mentioned, this can comprise at least one action corresponding to the discrepancy according to the action data, or a recommendation to initiate the at least one action. This can be issued, for example, to the vehicle 100 and/or the user 110.

1-11. (canceled)

12. A method for monitoring a technical system with regard to a change of state of a component of the technical system, comprising the following steps:
providing component data that include information about components of the technical system;
providing change data that include a plurality of change decompositions, wherein each of the change decompositions include one or more function blocks that are obtained by decomposing a description of a change of state with respect to the component of the technical system;
providing event data that include information about state change events, wherein each of the state change events indicate a change of state with respect to the component of the technical system; and
when there is a state change event:
providing a current history of context parameter values for context parameters, wherein the context parameters are each related to a context of the component of the technical system, and
determining, based on at least part of the current history of context parameter values and the change decompositions, whether there is a discrepancy between a state of the component and the change of state according to the state change event.

13. The method according to claim 12, wherein the technical system is a vehicle.

14. The method according to claim 12, further comprising:
when there is a discrepancy between the state of the component and the change of state according to the state change event:
determining at least one measure; and
providing information about the at least one measure and initiating the at least one measure.

15. The method according to claim 12, further comprising:
providing action data that include a plurality of action decompositions, wherein each of the action decompositions includes one or more function blocks that are obtained by decomposing an action to be carried out in the event of a discrepancy;
wherein the at least one measure includes at least one action corresponding to the discrepancy according to the action data, or a recommendation to initiate the at least one action.

16. The method according to claim 12, further comprising, repeatedly or continuously, during operation of the technical system:
determining available context parameter values for the context parameters; and
adding the available context parameter values to the current history of context parameter values.

17. The method according to claim 12, wherein there is or is deemed to be a state change event when at least one of the following criteria occurs:
the state change event is manually triggered externally;
the state change event is automatically triggered externally;
as part of an automatic, continuous, check, it is determined that there is a state change event.

18. The method according to claim 12, wherein the context parameters include one or more of the following parameters:
a performance of the component or of a part of the component;
a noise of the component or of a part of the component;
a vibration of the component or of a part of the component;
a wear and tear of the component or of a part of the component;
a heat resistance of the component or of a part of the component;
an actuation behavior of the component or of a part of the component;
a speed of the technical system;
a weight of the technical system;
a balance of the technical system.

19. The method according to claim 12, wherein the state change events include at least one of the following events:
performing maintenance on the component or on a part of the component;
replacing the component or a part of the component;
performing maintenance on the technical system or on a part of the technical system;
replacing a part of the technical system;
an accident involving the technical system;
tuning the component or the technical system or a part of the technical system;
lending the technical system to a third party.

20. The method according to claim 12, wherein the technical system is one of the following technical systems:
a vehicle, wherein the component is a brake;
a robot;
a building;
a smart home;
a smart town.

21. A computing unit that is configured to monitor a technical system with regard to a change of state of a component of the technical system, the computing unit being configured to perform the following steps comprising:
providing component data that include information about components of the technical system;
providing change data that include a plurality of change decompositions, wherein each of the change decompositions include one or more function blocks that are obtained by decomposing a description of a change of state with respect to the component of the technical system;
providing event data that include information about state change events, wherein each of the state change events indicate a change of state with respect to the component of the technical system; and
when there is a state change event:
providing a current history of context parameter values for context parameters, wherein the context parameters are each related to a context of the component of the technical system, and
determining, based on at least part of the current history of context parameter values and the change decompositions, whether there is a discrepancy between a state of the component and the change of state according to the state change event.

22. A non-transitory machine-readable storage medium on which is stored a computer program for monitoring a technical system with regard to a change of state of a component of the technical system, the computer program, when executed by a computing unit, causing the computing unit to perform the following steps:
providing component data that include information about components of the technical system;
providing change data that include a plurality of change decompositions, wherein each of the change decompositions include one or more function blocks that are obtained by decomposing a description of a change of state with respect to the component of the technical system;
providing event data that include information about state change events, wherein each of the state change events indicate a change of state with respect to the component of the technical system; and
when there is a state change event:
providing a current history of context parameter values for context parameters, wherein the context parameters are each related to a context of the component of the technical system, and
determining, based on at least part of the current history of context parameter values and the change decompositions, whether there is a discrepancy between a state of the component and the change of state according to the state change event.
